(19) United States
(12) Patent Application Publication
(10) Pub. No.: US 2026/0147773 A1
(43) Pub. Date: May 28, 2026

(54) RECOMMENDING DATA USING INTERACTION GRAPH

(71) Applicant: MASHANG CONSUMER FINANCE CO., LTD., Chongqing (CN)

(72) Inventor: Zhichao FAN, Chongqing (CN)

(21) Appl. No.: 19/310,836

(22) Filed: Aug. 26, 2025

(30) Foreign Application Priority Data
Nov. 25, 2024 (CN) 202411700516.7

(51) Int. Cl. G06F 16/2457; G06F 16/9535

(52) U.S. Cl. CPC G06F 16/24578; G06F 16/9535

(57) ABSTRACT

In a method for recommending data, an interaction graph is generated based on user information of a user and a plurality of types of recommendation information. A first embedding feature vector corresponding to the user and a plurality of second embedding feature vectors corresponding to the plurality of types of recommendation information are obtained based on the interaction graph. A recommendation value of each type of the plurality of types of recommendation information is determined based on the first embedding feature vector and the second embedding feature vector corresponding to the respective type of recommendation information. Recommendation data is transmitted to the user based on the recommendation value of each type of the plurality of types of recommendation information. Apparatus and non-transitory computer-readable storage medium counterpart embodiments are also contemplated.

### RELATED APPLICATION

The present application claims priority to Chinese Patent Application No. 202411700516.7, filed on Nov. 25, 2024, which is hereby incorporated by reference in its entirety.

### FIELD OF THE TECHNOLOGY

This application relates to the technical field of computers, including a method for recommending data.

### BACKGROUND OF THE DISCLOSURE

When a user uses an internet product or service, a system can recommend data in which the user may be interested, for example, recommend an advertisement to the user. Currently, data to be recommended is determined according to user preference. For example, a system determines user preference by analyzing historical data of the user, and then recommends data related to the user preference. The above method can cause low accuracy of data recommendation due to the user preference being in a single dimension. Furthermore, because the user preference possibly changes over time, recommended data possibly does not conform to current actual user preference. Thus, how to improve accuracy of data recommendation is a problem to be resolved currently.

### SUMMARY

Aspects of this disclosure include a method for recommending data, an apparatus, and a non-transitory computer-readable storage medium, which can improve accuracy of data recommendation.

Examples of technical solutions of this disclosure may be implemented as follows:

An aspect of this disclosure provides a method for recommending data. An interaction graph is generated based on user information of a user and a plurality of types of recommendation information. A first embedding feature vector corresponding to the user and a plurality of second embedding feature vectors corresponding to the plurality of types of recommendation information are obtained based on the interaction graph. A recommendation value of each type of the plurality of types of recommendation information is determined based on the first embedding feature vector and the second embedding feature vector corresponding to the respective type of recommendation information. Recommendation data is transmitted to the user based on the recommendation value of each type of the plurality of types of recommendation information.

An aspect of this disclosure provides an apparatus for recommending data. The apparatus includes processing circuitry configured to generate an interaction graph based on user information of a user and a plurality of types of recommendation information. The processing circuitry is configured to obtain a first embedding feature vector corresponding to the user and a plurality of second embedding feature vectors corresponding to the plurality of types of recommendation information based on the interaction graph. The processing circuitry is configured to determine a recommendation value of each type of the plurality of types of recommendation information based on the first embedding feature vector and the second embedding feature vector corresponding to the respective type of recommendation information. The processing circuitry is configured to transmit recommendation data to the user based on the recommendation value of each type of the plurality of types of recommendation information.

An aspect of this disclosure provides a method for recommending data. The method includes: generating an interaction graph according to user information of a user and a plurality of types of recommendation information; performing encoding on the interaction graph, and obtaining a first embedding feature vector corresponding to the user and a second embedding feature vector corresponding to each type of recommendation information; determining a recommendation value of each type of recommendation information according to the first embedding feature vector and the second embedding feature vector corresponding to the recommendation information; and transmitting recommendation data to the user according to the recommendation value of each type of recommendation information.

An aspect of this disclosure provides an apparatus for recommending data. The apparatus includes: a generating unit configured to generate an interaction graph according to user information of a user and a plurality of types of recommendation information; a processing unit configured to perform encoding on the interaction graph, and obtain a first embedding feature vector corresponding to the user and a second embedding feature vector corresponding to each type of recommendation information, the processing unit being further configured to determine a recommendation value of each type of recommendation information according to the first embedding feature vector and the second embedding feature vector corresponding to the recommendation information; and a recommending unit configured to transmit recommendation data to the user according to the recommendation value of each type of recommendation information.

Correspondingly, an aspect of this disclosure provides a computer device. The computer device includes: a processor suitable for implementing a computer program; and a computer-readable storage medium having the computer program stored therein, the computer program being suitable for being loaded by the processor to perform the above method for recommending data.

An aspect of this disclosure provides a non-transitory computer-readable storage medium, having computer-executable instructions stored therein, the computer-executable instructions, when executed by a processor, cause the processor to implement the method for recommending data.

Correspondingly, an aspect of this disclosure provides a computer program product. The computer program product includes a computer program, the computer program being stored in a computer-readable storage medium. A processor of a computer device reads the computer program from the computer-readable storage medium. The processor executes the computer program to cause the computer device to perform the above method for recommending data.

According to the aspects of this disclosure, an interaction graph is generated according to user information of a user and a plurality of types of recommendation information. Then, encoding is performed on the interaction graph, and a first embedding feature vector corresponding to the user and a second embedding feature vector corresponding to each type of recommendation information are obtained. A recommendation value of each type of recommendation information is determined according to the first embedding feature vector and the second embedding feature vector corresponding to the recommendation information. Recommendation data is transmitted to the user according to the recommendation value of each type of recommendation information. According to the above method, by performing the encoding on the interaction graph, the first embedding feature vector and the second embedding feature vector that are obtained through the encoding are aggregated with various complex interaction relationships between the user and the recommendation information. Then, the recommendation value of each type of recommendation information is generated according to the first embedding feature vector and the second embedding feature vector. Based on this, data recommendation is performed. In this way, through this method, the data recommendation can be performed by comprehensively considering various complex interaction relationships between the user and various types of recommendation information instead of relying on only a single type of data (such as user preference). Thus, accuracy of the data recommendation is improved.

### BRIEF DESCRIPTION OF THE DRAWINGS

In order to describe the technical solutions of the aspects of this disclosure, the accompanying drawings are briefly introduced below.

FIG. 1 is a schematic architectural diagram of a system for recommending data according to an aspect of this disclosure;

FIG. 2 is a schematic flowchart of a method for recommending data according to an aspect of this disclosure;

FIG. 3 is a schematic flowchart of another method for recommending data according to an aspect of this disclosure;

FIG. 4A is a schematic diagram of generating an interaction graph according to an aspect of this disclosure;

FIG. 4B is a schematic diagram of determining a first embedding feature vector according to an aspect of this disclosure;

FIG. 4C is a schematic diagram of a flow for recommending data according to an aspect of this disclosure;

FIG. 5 is a schematic structural diagram of an apparatus for recommending data according to an aspect of this disclosure; and

FIG. 6 is a schematic structural diagram of a computer device according to an aspect of this disclosure.

### DETAILED DESCRIPTION

The technical solutions of the aspects of this disclosure are described below in combination with the accompanying drawings. The described aspects are merely some aspects rather than all aspects of this disclosure. Other aspects are within the scope of this disclosure. The descriptions of the terms are provided as examples only and are not intended to limit the scope of the disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

A system for recommending data provided in an aspect of this disclosure is described below in combination with accompanying drawings. The system for recommending data is suitable for implementing a method for recommending data provided in an aspect of this disclosure.

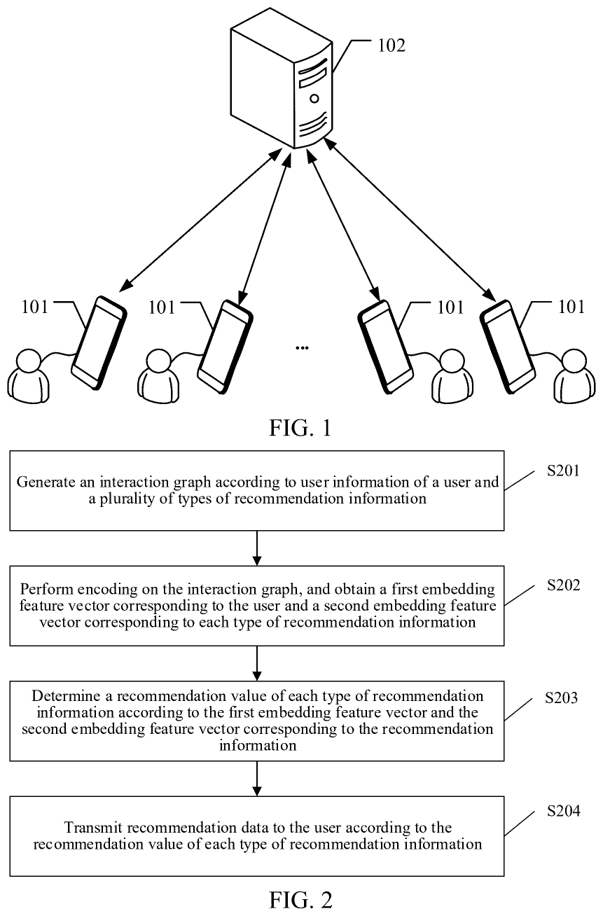

With reference to FIG. 1, a schematic architectural diagram of a system for recommending data according to an aspect of this disclosure is shown in this figure. The system for recommending data may specifically include a terminal device 101 and a server 102. The terminal device 101 is connected to the server 102 by using a network, such as a local area network, a wide area network, or a mobile internet.

The terminal device 101 may alternatively be referred to as a terminal, user equipment (UE), an access terminal, a user unit, a mobile device, a user terminal, a wireless communications device, a user agent, or a user apparatus. The terminal device may be a smart appliance, a handheld device (such as a smartphone or a tablet computer) having a wireless communication function, a computing device (such as a personal computer (PC)), an in-vehicle terminal, an intelligent voice interaction device, a wearable device, or another intelligent apparatus, etc., but is not limited thereto. In an aspect of this disclosure, the terminal device 101 may refer to a device used by a user to access a page (or an application). When the user accesses the page (or the application), data recommendation (such as advertisement recommendation) may be triggered.

The server 102 may be an independent physical server, or may be a server cluster or a distributed system including a plurality of physical servers, or may be a cloud server providing basic cloud computing services, such as a cloud service, a cloud database, cloud computing, a cloud function, cloud storage, a network service, cloud communication, a middleware service, a domain name service, a security service, a content delivery network (CDN), and a big data and artificial intelligence platform. In an aspect of this disclosure, the server 102 may refer to a background server corresponding to a system for recommending data, and may be configured to determine recommendation data (such as an advertisement), and transmit the recommendation data to the terminal device 101 such that the recommendation data can be displayed on the terminal device 101.

In a possible implementation, when a user accesses a page (or an application) by using the terminal device 101, data recommendation (such as advertisement recommendation) may be triggered. Then, the terminal device 101 transmits a data acquisition request to the server 102. The data acquisition request is configured for acquiring recommendation data from the server 102. The recommendation data is displayed in a display area of the page (or the application) (for example, an advertisement is displayed at an advertising position). Based on this, the server 102 may generate, in response to the recommendation data acquisition request, an interaction graph according to user information of the user and a plurality of types of recommendation information (such as a plurality of advertisements). The interaction graph is a graph data structure, and is configured for representing complex interaction relationships between the user and the plurality of types of recommendation information. Then, the server 102 performs encoding on the interaction graph, obtains a first embedding feature vector corresponding to the user and a second embedding feature vector corresponding to each type of recommendation information, and determines a recommendation value of each type of recommendation information according to the first embedding feature vector and the second embedding feature vector corresponding to the recommendation information. The recommendation value is configured for indicating a recommendation degree of the recommendation information. The server 102 may transmit recommendation data (for example, the recommendation data may include an advertisement (that is, the recommendation information), a link corresponding to an advertisement, and an advertiser) to the user according to the recommendation value of each type of recommendation information.

In a possible implementation, in a process of transmitting the recommendation data to the user according to the recommendation value of each type of recommendation information, the server 102 may determine a number of pieces of recommendation data (one or more pieces of recommendation data may exist, for example, one or more advertisements mat exist, and the number of pieces of recommendation data may be determined according to a service situation) according to the recommendation value of each type of recommendation information, and then transmit the determined one or more pieces of recommendation data to the terminal device 101 such that the terminal device 101 can display, in a display area, the recommendation data transmitted by the server 102.

The schematic architectural diagram of the system described in an aspect of this disclosure is intended to describe an example of the technical solution of the aspect of this disclosure, and does not constitute a limitation on the technical solution provided in the aspect of this disclosure. For example, the method for recommending data provided in an aspect of this disclosure not only may be performed by the server 102, but also may be performed by another server or server cluster that is different from the server 102 and can communicate with the terminal device 101 and/or the server 102. It is noted that the number of terminal devices and the number of servers in FIG. 1 are merely some examples. Any number of terminal devices and any number of servers may be configured according to a service implementation requirement. Moreover, with evolution of system architectures and emergence of new service scenarios, the technical solutions provided in the aspects of this disclosure are further suitable for similar technical problems. In the subsequent aspects, a terminal device is used to refer to the above terminal device 101, and a server is used to refer to the above server 102.

The method for recommending data provided in an aspect of this disclosure are described in more detail below in combination with accompanying drawings.

An aspect of this disclosure provides a method for recommending data. The method for recommending data may be performed by a computer device. The computer device may be the server 102 in the system for recommending data shown in FIG. 1 for example. As shown in FIG. 2, the method for recommending data may include but is not limited to operation S201 to operation S204 as follows:

S201: Generate an interaction graph according to user information of a user and a plurality of types of recommendation information. For example, an interaction graph is generated based on user information of a user and a plurality of types of recommendation information.

A user in an aspect of this disclosure refers to an object for which data recommendation is required to be performed. For example, when a user accesses a page (or an application), data recommendation may be performed for the user. The recommendation information refers to an object recommended to the user, such as an advertisement, video, and a web page. The subsequent aspects are described with an advertisement as an example.

In a possible implementation, the user information of the user may include one or more types of attribute information of the user and interaction information between the user and the recommendation information. For example, the attribute information of the user may include one or more types of a user feature (such as a gender and an age) of the user and user preference (such as a user interest and a user label). The interaction information between the user and the recommendation information may include one or more types of page browsing data (such as an interface browsing record), click-through/tap-through data (such as an advertisement click-through/tap-through record), dwell data (such as advertisement dwell data), and conversion data (such as advertisement conversion data obtained after the user clicks on/taps on an advertisement. For example, the advertisement conversion data may indicate whether a product corresponding to an advertisement is purchased).

In a possible implementation, the recommendation information may include one or more types of content data and metadata. For example, the content data may include one or more types of text data (such as an advertisement title and an advertisement content introduction), image data (such as an advertisement picture), video data (such as advertisement video), and audio data (such as advertisement audio). The metadata may include one or more types of a resource category (such as an advertisement category) and a resource strategy (such as a target audience and an advertising strategy).

In an aspect of this disclosure, a computer device may generate an interaction graph according to user information of a user and a plurality of types of recommendation information. The interaction graph herein refers to an interaction graph between the user and the plurality of types of recommendation information (such as an advertisement). The interaction graph includes at least a user node and a plurality of recommendation information nodes (each type of recommendation information corresponds to one recommendation information node). All nodes have node connection relationships with one another. For example, if the user browses a piece of recommendation information, a user node is connected to a recommendation information node corresponding to the recommendation information. Moreover, a connecting edge may include weight information. The weight information may represent interaction intensity, for example, represent information such as a click-through/tap-through number and dwell time of the user on the recommendation information.

For example, the interaction graph may be marked as G=(V, E), where V represents a node set, and E represents an edge set. For example, an edge between adjacent nodes u and y can be represented by e=(u, y). The interaction graph may alternatively be a graph in another form that can represent a node and a node connection relationship. This is not limited in the aspect.

S202: Perform encoding on the interaction graph, and obtain a first embedding feature vector corresponding to the user and a second embedding feature vector corresponding to each type of recommendation information. For example, a first embedding feature vector corresponding to the user and a plurality of second embedding feature vectors corresponding to the plurality of types of recommendation information are obtained based on the interaction graph.

In an aspect of this disclosure, a computer device may perform encoding on the interaction graph, and obtain a first embedding feature vector corresponding to the user and a second embedding feature vector corresponding to each type of recommendation information. The encoding refers to a process of extracting, from the interaction graph, an embedding feature vector aggregated with an interaction relationship between the user and the recommendation information. A graph neural network (GNN) is involved in the encoding. The graph neural network transmits feature information of each node to a neighboring node thereof by using an information propagation mechanism. An embedding feature vector of each node is updated by aggregating information of the neighboring node. An embedding feature vector (such as a first embedding feature vector corresponding to the user and a second embedding feature vector corresponding to each type of recommendation information) of each node is finally obtained. Through the above method, the first embedding feature vector not only includes the user information of the user, but also is aggregated with the recommendation information. Similarly, the second embedding feature vector corresponding to each type of recommendation information not only includes the recommendation information, but also is aggregated with the user information.

In a possible implementation, the computer device may input the interaction graph to a graph sample and aggregate (GraphSAGE) framework for encoding, and then obtain the first embedding feature vector corresponding to the user and the second embedding feature vector corresponding to each type of recommendation information.

S203: Determine a recommendation value of each type of recommendation information according to the first embedding feature vector and the second embedding feature vector corresponding to the recommendation information. For example, a recommendation value of each type of the plurality of types of recommendation information is determined based on the first embedding feature vector and the second embedding feature vector corresponding to the respective type of recommendation information.

In an aspect of this disclosure, since the first embedding feature vector and the second embedding feature vector corresponding to the recommendation information are both aggregated with the interaction relationships between the user and the recommendation information, the computer device can compute a recommendation value corresponding to each type of recommendation information according to the first embedding feature vector and the second embedding feature vector of each type of recommendation information. The recommendation value corresponding to each type of recommendation information may be configured for indicating a recommendation degree of recommending the recommendation information to the user. According to the above method, by computing the recommendation value corresponding to each type of recommendation information, a matching degree between the user and the recommendation information is quantified. The computed recommendation value corresponding to each type of recommendation information provides a basis for subsequent data recommendation.

In a possible implementation, the computer device may compute a predicted triggering probability between the first embedding feature vector and the second embedding feature vector corresponding to each type of recommendation information. The predicted triggering probability refers to a probability that a user triggers the recommendation information (for example, a probability that a user clicks on/taps on an advertisement). The computer device then determines a recommendation value corresponding to each type of recommendation information according to the computed predicted triggering probability. Example implementations are described in the subsequent aspects and not repeated herein.

S204: Transmit recommendation data to the user according to the recommendation value of each type of recommendation information. For example, recommendation data is transmitted to the user based on the recommendation value of each type of the plurality of types of recommendation information.

In an aspect of this disclosure, the computer device may determine to-be-recommended data (that is, recommendation data) for the user according to the recommendation value of each type of recommendation information, and transmit the recommendation data to the user.

In a possible implementation, the recommendation data may include one or more types of recommendation information. The recommendation data may alternatively include one or more types of recommendation information and related information corresponding to the one or more types of recommendation information. The recommendation information may refer to an advertisement. Related information corresponding to the recommendation information may include a link corresponding to an advertisement, an advertiser, etc. A number of pieces of recommendation information included in the recommendation data may be determined according to a service situation. This is not limited in the aspects of this disclosure.

For example, the computer device may determine, according to a descending order of recommendation values corresponding to all types of recommendation information, a plurality of types of recommendation information having high recommendation values (or recommendation information having a highest recommendation value) from all types of recommendation information, generate recommendation data according to the determined recommendation information, and then transmit the recommendation data to the user.

Based on the above aspects, this disclosure can have beneficial effects as follows: According to the aspects of this disclosure, an interaction graph is generated according to user information of a user and a plurality of types of recommendation information. Then, encoding is performed on the interaction graph, and a first embedding feature vector corresponding to the user and a second embedding feature vector corresponding to each type of recommendation information are obtained. A recommendation value of each type of recommendation information is determined according to the first embedding feature vector and the second embedding feature vector corresponding to the recommendation information. Recommendation data is transmitted to the user according to the recommendation value of each type of recommendation information. According to the above method, by performing the encoding on the interaction graph, the first embedding feature vector and the second embedding feature vector that are obtained through the encoding are aggregated with various complex interaction relationships between the user and the recommendation information. Then, the recommendation value of each type of recommendation information is generated according to the first embedding feature vector and the second embedding feature vector. Based on this, data recommendation is performed. Through this method, the data recommendation can be performed by comprehensively considering various complex interaction relationships between the user and various types of recommendation information instead of relying on only a single type of data (such as user preference). Thus, accuracy of the data recommendation is improved.

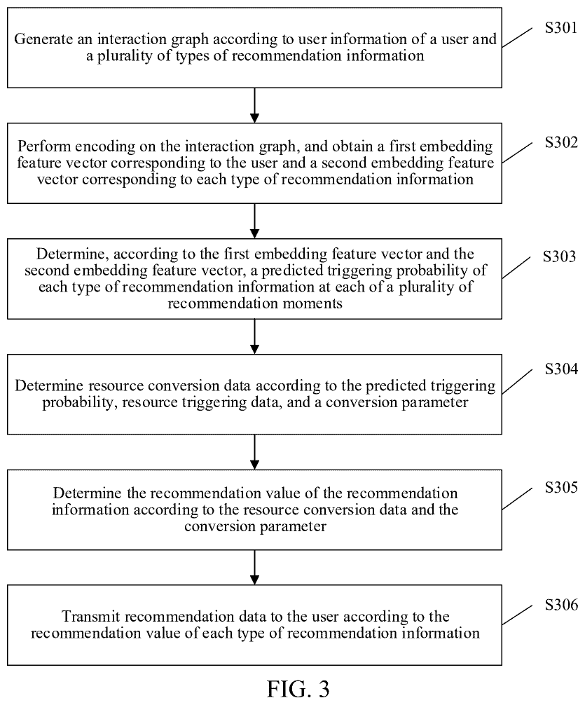

An aspect of this disclosure provides another method for recommending data. The method for recommending data may be performed by a computer device. The computer device may be the server 102 in the system for recommending data shown in FIG. 1 for example. As shown in FIG. 3, the method for recommending data may include but is not limited to operation S301 to operation S306 as follows:

S301: Generate an interaction graph according to user information of a user and a plurality of types of recommendation information. For example, an interaction graph is generated based on user information of a user and a plurality of types of recommendation information.

In a possible implementation, an implementation of operation S301 mentioned above may include operation (1) to operation (3) as follows:

(1) Construct a user node according to the user information of the user, and construct a recommendation information node corresponding to each type of recommendation information according to each type of recommendation information. The user node includes attribute information of the user and interaction information between the user and the recommendation information.

In a possible implementation, the computer device may construct a user node corresponding to the user according to the user information of the user. For example, the user information may include attribute information (such as a gender, an age, a user interest, and a user label) of the user, and interaction information (such as an interface browsing record, an advertisement click-through/tap-through record, advertisement dwell data, and advertisement conversion data) between the user and the recommendation information. Sources of the user information may include a browser plug-in, a mobile application, an advertisement click-through/tap-through monitoring and detection tool, etc.

In a possible implementation, the computer device may construct a recommendation information node corresponding to each type of recommendation information. For example, the recommendation information may include one or more types of content data (such as an advertisement title, an advertisement content introduction, an advertisement picture, advertisement video, and advertisement audio) and metadata (such as an advertisement category, a target audience, and an advertising strategy). Sources of the recommendation information may include an advertisement content management system, an advertisement material library, etc.

In an aspect of this disclosure, the computer device may perform data encoding on the user information of the user, obtain encoded information, and construct a user node according to the encoded information. For example, the computer device may perform encoding on the user information by using a sequence model, such that a feature vector is obtained. A recurrent neural network (RNN) model, or a long short-term memory (LSTM) model, etc. may be used as the sequence model.

In an aspect of this disclosure, the computer device may perform data encoding on each type of recommendation information, obtain encoded information, and construct a recommendation information node according to the encoded information. For example, a text in the content data may be converted to a vector by using a word embedding model. A word to vector (Word2vec) model, or a bidirectional encoder representations from transformers (BERT) model, etc. may be used as the word embedding model. An image feature of an image in the content data may be extracted by using convolutional neural networks (CNN) such that data encoding can be implemented. A video feature of video in the content data may be extracted by using three-dimensional (3D) convolutional neural networks, a time sequence model (such as a long short-term memory model), etc. such that data encoding can be implemented.

(2) Acquire environment information when data recommendation is performed for the user, and construct an environment node according to the environment information.

In a possible implementation, the computer device may construct an environment node according to environment information when data recommendation is performed for the user (which may be understood as follows: construct a context node according to context information). The environment information may include time, a device type of a device (marked as an object device) used by the user, an operating system, a network type, a geographical position, etc. Sources of the environment information may include user equipment, a browser, a global positioning system (GPS), an internet protocol (IP) address, etc.

In an aspect of this disclosure, the computer device may perform data encoding on the environment information, and obtain encoded information; and construct an environment node based on the encoded information. For example, the computer device may perform data encoding on the environment information through one-hot encoding, feature embedding, etc.

(3) Generate the interaction graph according to the user node, the recommendation information node, the environment node, and node connection relationships.

In an aspect of this disclosure, the node connection relationship represents an interaction situation between nodes. The node connection relationship may include an edge between nodes, and the edge may have a weight. For example, if the user browses a piece of recommendation information, a user node corresponding to the user is connected to a recommendation information node corresponding to the recommendation information. Moreover, a connecting edge may include weight information. The weight information may represent interaction intensity, for example, represent information such as a click-through/tap-through number and dwell time of the user on the recommendation information. Similarly, the user may be connected to the environment node by using an edge.

In a possible implementation, the recommendation information may be connected to the recommendation information by using an edge. For example, if two pieces of recommendation information belong to the same type (or are provided by the same provider), weights of edges corresponding to the two pieces of recommendation information may be configured for representing that types (or providers) of the two pieces of recommendation information are the same.

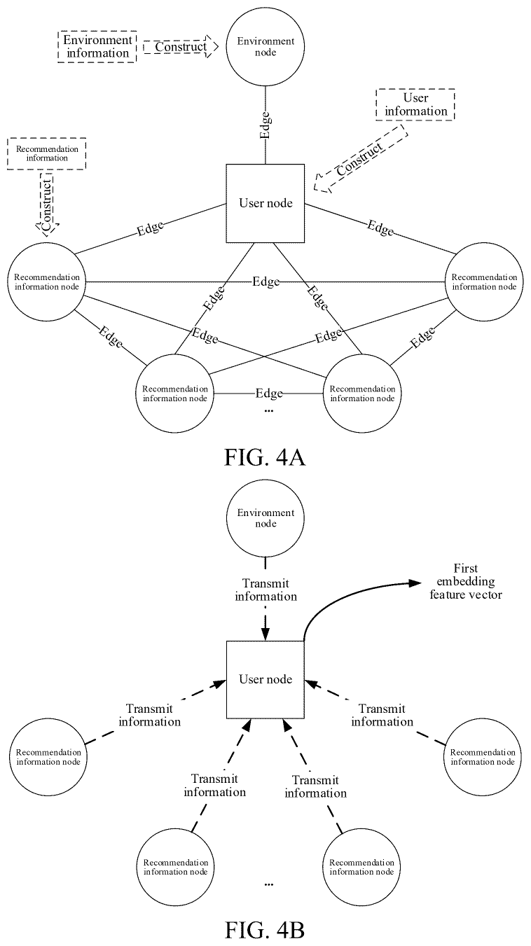

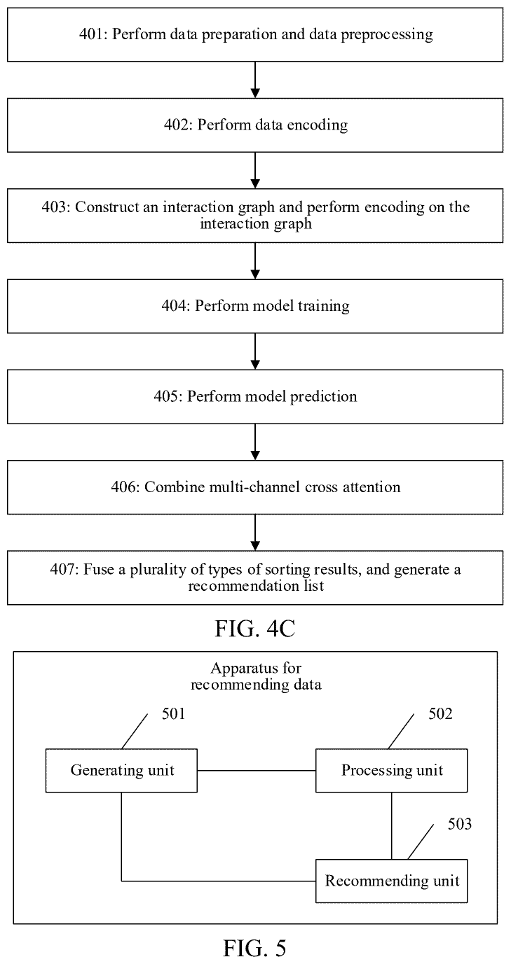

The interaction graph can be generated according to operation (1) to operation (3) mentioned above. An example implementation process can be obtained with reference to FIG. 4A. FIG. 4A is a schematic diagram of generating an interaction graph according to an aspect of this disclosure.

S302: Perform encoding on the interaction graph, and obtain a first embedding feature vector corresponding to the user and a second embedding feature vector corresponding to each type of recommendation information. For example, a first embedding feature vector corresponding to the user and a plurality of second embedding feature vectors corresponding to the plurality of types of recommendation information are obtained based on the interaction graph.

In a possible implementation, an implementation of operation S302 mentioned above may include operation (1) and operation (2) as follows:

(1) Perform information aggregation on a user node and a first association node in the interaction graph, and obtain the first embedding feature vector corresponding to the user.

In an aspect of this disclosure, the first association node includes a recommendation information node having a connection relationship with the user node. Based on this, the computer device performs information aggregation on the user node and the first association node in the interaction graph, such that the first embedding feature vector not only includes a feature of the user information, but also is integrated with a feature of the recommendation information having an interaction relationship with the user. In addition, the first association node may further include an environment node. Then, the first embedding feature vector is further integrated with a feature of the environment node.

As shown in FIG. 4B, a schematic diagram of determining a first embedding feature vector according to an aspect of this disclosure is shown in FIG. 4B. The first association node may include each recommendation information node having a connection relationship with the user node, and an environment node. Then, during information aggregation, the user node may acquire information from the first association node. That is, the first association node transmits the information to the user node. Further, the computer device may obtain a first embedding feature vector corresponding to the user node.

(2) Perform information aggregation on a recommendation information node corresponding to each type of recommendation information and a second association node in the interaction graph, and obtain the second embedding feature vector corresponding to the recommendation information.

In an aspect of this disclosure, the second association node includes a recommendation information node having a connection relationship with the recommendation information node, and the user node. Based on this, the computer device performs information aggregation on the recommendation information node corresponding to the recommendation information and the second association node in the interaction graph, such that the second embedding feature vector not only includes a feature of the recommendation information, but also is integrated with a feature of another piece of recommendation information having an interaction relationship with the recommendation information and a feature of the user. In addition, the second association node may further include an environment node. Then, the second embedding feature vector is further integrated with a feature of the environment node.

A method for determining a recommendation value corresponding to each type of recommendation information according to the first embedding feature vector and the second embedding feature vector of each type of recommendation information is introduced below by operation S303 to operation S305.

S303: Determine, according to the first embedding feature vector and the second embedding feature vector, a predicted triggering probability of each type of recommendation information at each of a plurality of recommendation moments. For example, a predicted triggering probability of the respective type of recommendation information at each recommendation time point of a plurality of recommendation time points is determined based on the first embedding feature vector and the second embedding feature vector.

In a possible implementation, an implementation of operation S303 mentioned above may include operation (1) to operation (3) as follows:

(1) Perform feature fusion on embedding feature vectors of a plurality of channels included in the first embedding feature vector, and obtain a first fused embedding feature vector.

In a possible implementation, the first embedding feature vector includes embedding feature vectors of a plurality of channels. For example, the embedding feature vectors of the plurality of channels may refer to: embedding feature vectors corresponding to data in at least two dimensions of a gender, an age, a user interest, a user label, an interface browsing record, an advertisement click-through/tap-through record, advertisement dwell data, and advertisement conversion data. In the above method, features of the user in a plurality of dimensions are represented more comprehensively by using the first fused embedding feature vector, such that accuracy of data recommendation is improved.

(2) Perform feature fusion on embedding feature vectors of a plurality of channels included in the second embedding feature vector, and obtain a second fused embedding feature vector.

In a possible implementation, the second embedding feature vector includes embedding feature vectors of a plurality of channels. The embedding feature vectors of the plurality of channels may refer to: embedding feature vectors corresponding to data in at least two dimensions of an advertisement title, an advertisement content introduction, an advertisement picture, advertisement video, advertisement audio, an advertisement category, a target audience, and an advertising strategy. In the above method, features of the recommendation information in a plurality of dimensions are represented more comprehensively by using the second fused embedding feature vectors, such that accuracy of data recommendation is improved.

(3) Perform matching on the first fused embedding feature vector and the second fused embedding feature vector, and obtain the predicted triggering probability of the recommendation information at each of the plurality of recommendation moments.

In a possible implementation, the computer device may input the first fused embedding feature vector and the second fused embedding feature vector corresponding to the recommendation information to a data recommendation model for matching, and obtain a predicted triggering probability of the recommendation information at each of a plurality of recommendation moments. The predicted triggering probability herein may refer to a matching degree between the first fused embedding feature vector and the second fused embedding feature vector. The higher a matching degree is, the higher a predicted triggering probability is (for example, the higher a predicted advertisement click-through/tap-through probability is). The predicted triggering probability of the recommendation information at each of the plurality of recommendation moments is configured for computing a recommendation value of the recommendation information. The recommendation value is configured for indicating an overall triggering benefit (such as a total expected benefit) of the recommendation information.

In a possible implementation, an implementation of operation (1) to perform feature fusion on embedding feature vectors of a plurality of channels included in the first embedding feature vector and obtain a first fused embedding feature vector may include operation (i) to operation (iii) as follows:

(i) Determine a query vector, a key vector, and a value vector that correspond to an embedding feature vector of each channel in the first embedding feature vector.

In an aspect of this disclosure, the computer device may acquire global dependency relationships between all channels by using a cross attention mechanism so as to comprehensively consider an embedding feature vector of each channel. A query vector, a key vector, and a value vector that correspond to the embedding feature vector of each channel refer to a query vector Query, a key vector Key, and a value vector Value of the embedding feature vector of each channel.

In a possible implementation, assuming that a first embedding feature vector includes embedding feature vectors of two channels i and j, the computer device computes a query vector (marked as Qᵢ) corresponding to an embedding feature vector of the channel i and a key vector (marked as Kⱼ) and a value vector (marked as Vⱼ) corresponding to an embedding feature vector of the channel j. Computation formulas may be as follows: where

$${Q}_{i} = {W}_{{Q}_{i}} \times {F}_{i}$$

$${K}_{j} = {W}_{{K}_{j}} \times {F}_{j}$$

$${V}_{j} = {W}_{{V}_{j}} \times {F}_{j}$$

W_{Q}_{ᵢ}, W_{K}_{ⱼ}, and W_{V}_{ⱼ} are linear transformation matrices, Fᵢ is the embedding feature vector of the channel i, and Fⱼ is the embedding feature vector of the channel j.

(ii) Determine a channel weight of each channel according to the query vector, the key vector, and the value vector that correspond to the embedding feature vector of the channel.

In a possible implementation, assuming that a first embedding feature vector includes embedding feature vectors of two channels i and j, the computer device computes a channel weight (marked as) of the channel i according to a query vector corresponding to an embedding feature vector of the channel i and a key vector and a value vector that correspond to an embedding feature vector of the channel j. A computation formula may be as follows: where

$$Attention ( i ) = soft max ( \frac{{Q}_{i} \times {K}_{j}^{T}}{\sqrt{d k}} )$$

dk is a dimension of a key, and is configured for scaling a dot product. The channel weight of the channel j may be marked as Attention (j). A computation method can be obtained with reference to an example implementation of computing the channel weight of the channel i.

(iii) Determine the first fused embedding feature vector according to the embedding feature vector and the channel weight of each channel.

In an aspect of this disclosure, the computer device may perform weighted summation on the embedding feature vector and the channel weight of each channel included in the first embedding feature vector, and obtain a first fused embedding feature vector.

In a possible implementation, assuming that the first embedding feature vector includes embedding feature vectors of two channels i and j, a first fused embedding feature vector may be marked as F′. A computation formula may be as follows:

$${F}^{′} = {F}_{i} \times Attention ( i ) + {F}_{j} \times Attention ( j )$$

An example implementation of operation (2) mentioned above, that is, perform feature fusion on embedding feature vectors of a plurality of channels included in the second embedding feature vector, and obtain a second fused embedding feature vector, can be obtained with reference to the related descriptions of obtaining the first fused embedding feature vector in operation (1).

S304: Determine resource conversion data according to the predicted triggering probability, resource triggering data, and a conversion parameter. For example, resource conversion data is determined based on the predicted triggering probability, resource triggering data, and a conversion parameter.

In an aspect of this disclosure, the resource triggering data is configured for indicating a benefit brought by triggering a resource. For example, the resource triggering data may include a click-through/tap-through benefit of the recommendation information (such as an advertisement). In a possible implementation, the click-through/tap-through benefit may be acquired by the computer device from an advertising platform. The click-through/tap-through benefit is configured for indicating a fee required to be paid by an advertiser to the advertising platform after a user clicks on/taps on an advertisement. Click-through/tap-through benefits corresponding to advertisements may be the same or different. This is not limited in the aspects of this disclosure.

In an aspect of this disclosure, the conversion parameter is configured for converting a future benefit to a benefit at a current moment such that a total expected benefit (that is, an overall benefit) can be computed by using an instant benefit. The conversion parameter determines a weight of the future benefit in the total expected benefit. A high conversion parameter (for example, close to 1) represents a high degree of emphasis on a future benefit. A low conversion parameter (for example, close to 0) represents a low degree of emphasis on a future benefit.

In a possible implementation, the computer device may determine a plurality of pieces of resource conversion data according to the predicted triggering probability, the resource triggering data, and the conversion parameter of the recommendation information at each recommendation moment. Each piece of resource conversion data represents a predicted benefit at a moment. For example, the computer device may multiply a predicted triggering probability at a recommendation moment by a click-through/tap-through benefit, and obtain resource conversion data corresponding to the recommendation moment.

S305: Determine the recommendation value of the recommendation information according to the resource conversion data and the conversion parameter. For example, the recommendation value of the respective type of recommendation information is determined based on the resource conversion data and the conversion parameter.

In a possible implementation, a plurality of pieces of resource conversion data may exist. The plurality of pieces of resource conversion data may include first resource conversion data (such as an instant benefit) and second resource conversion data (such as a future benefit). The first resource conversion data is resource conversion data corresponding to a current recommendation moment. The second resource conversion data is resource conversion data (that is, resource conversion data corresponding to each recommendation moment of the plurality of recommendation moments other than the current recommendation moment) of the plurality of pieces of resource conversion data other than the first resource conversion data. That is, one or more pieces of second resource conversion data may exist.

Then, the computer device may take a product of the second resource conversion data (such as the future benefit) and the conversion parameter as a future conversion benefit, sum the first resource conversion data (such as the instant benefit) and the future conversion benefit, and obtain an overall click-through/tap-through benefit (that is, an overall triggering benefit).

A specific computation method for a recommendation value is described as follows: The recommendation value may alternatively be referred to as a vestigial value (marked as VTG). For example, the recommendation information is a target advertisement, the data recommendation model may predict, for a plurality of advertisement actions (for example, recommendations on the target advertisement at a plurality of recommendation moments), predicted click-through/tap-through probabilities of the target advertisement at the plurality of recommendation moments. The predicted click-through/tap-through probabilities may be marked as CTR(Sₜ, Aₜ), where Sₜ includes a first embedding feature vector corresponding to the user and a second embedding feature vector corresponding to the target advertisement, Aₜ refers to an advertisement action, and Aₜ represents that at recommendation moment t, the target advertisement is recommended to the user. The conversion parameter may be marked as λ. The first resource conversion data (that is, the instant benefit) may be marked as Rₜ. A computation formula may be as follows:

$${R}_{t} = C T R ( {S}_{t} , {A}_{t} ) \times λ$$

The second resource conversion data (that is, the future benefit) may be marked as Vₜ₊₁. A computation formula may be as follows: where

$${V}_{t + 1} = {Max}_{{A}_{t + 1}} E ( {R}_{t + 1} + λ \times {V}_{t + 2} )$$

E represents an expected value, Aₜ₊₁ represents a target advertisement recommended to a user at recommendation moment t+1, and Max_{A}_{ₜ₊₁} represents that a selection of a future benefit that can be maximized. The future benefit can be computed through the above recursive method.

The computer device then determines a recommendation value (that is, a vestigial value VTG) corresponding to the target advertisement according to the first resource conversion data (that is, the instant benefit), the second resource conversion data (that is, the future benefit), and the conversion parameter. The recommendation value may be configured for representing a total expected benefit brought by clicking/tapping on the target advertisement by the user. A computation formula for a recommendation value may be as follows:

$$V T G ( {S}_{t} , {A}_{t} ) = {R}_{t} + λ \times {V}_{t + 1}$$

S306: Transmit recommendation data to the user according to the recommendation value of each type of recommendation information. For example, recommendation data is transmitted to the user based on the recommendation value of each type of the plurality of types of recommendation information.

In a possible implementation, an implementation of operation S306 mentioned above may include operation (1) and operation (2) as follows:

(1) Determine a plurality of types of candidate recommendation information from the plurality of types of recommendation information according to the recommendation value of each type of recommendation information.

(2) Transmit the recommendation data to the user based on the plurality of types of candidate recommendation information.

In operation (1) and operation (2) mentioned above, the computer device may determine the plurality of types of candidate recommendation information from the plurality of types of recommendation information according to the recommendation value corresponding to each type of recommendation information. For example, a plurality of types of candidate recommendation information are determined from the plurality of types of recommendation information according to a descending order of the recommendation values. Then, the computer device may transmit recommendation data to the user based on the plurality of types of candidate recommendation information.

For example, assuming that a service requirement indicates that a plurality of pieces of recommendation information may be recommended to a user currently (for example, a plurality of advertisements are simultaneously pushed), the computer device may simultaneously recommend a plurality of types of candidate recommendation information to the user. Assuming that a service requirement indicates that one piece of recommendation information may be recommended to a user currently (for example, only one advertisement is pushed currently), the computer device may recommend candidate recommendation information having a maximum recommendation value (such as a maximum vestigial value VTG) of a plurality of types of candidate recommendation information to the user. In addition, the computer device may determine final candidate recommendation information by comprehensively considering a recommendation value of each of the plurality of types of candidate recommendation information and another recommendation strategy, and push the final candidate recommendation information to the user.

In a possible implementation, an implementation of operation (2) to transmit the recommendation data to the user based on the plurality of types of candidate recommendation information may include operation (1) to operation (4) as follows:

(1) Perform data value sorting on the plurality of types of candidate recommendation information, and obtain a first sorting result.

In an aspect of this disclosure, the computer device may perform data value sorting on the plurality of types of candidate recommendation information. For example, the computer device determines a first sorting result according to a descending order of recommendation values corresponding to all types of candidate recommendation information. The first sorting result is configured for indicating recommendation priority of recommending a plurality of types of candidate recommendation information to the user.

In a possible implementation, the recommendation value may be a vestigial value (VTG value). Then, the computer device may sequentially determine a sorting value of each type of candidate recommendation information according to a descending order of vestigial values, and then determine the first sorting result according to sorting values of the plurality of types of candidate recommendation information. For example, a sorting value of candidate recommendation information having a greatest vestigial value is 1, which represents highest recommendation priority, a sorting value of candidate recommendation information having a second greatest vestigial value is 2, which represents second highest recommendation priority, and so on.

(2) Perform index sorting on the plurality of types of candidate recommendation information, and obtain a second sorting result.

In an aspect of this disclosure, the computer device may obtain a second sorting result of the plurality of types of candidate recommendation information through index sorting so as to determine a third sorting result (that is, a fused sorting result) of the plurality of types of candidate recommendation information according to the first sorting result and the second sorting result. Thus, accuracy of a sorting result can be improved, and accuracy of data recommendation can be improved.

In a possible implementation, index sorting may include two types of processing, that is, phrase prefix matching and hybrid vector indexing. Based on this, an implementation of operation (2) to perform index sorting on the plurality of types of candidate recommendation information and obtain a second sorting result may include operations (i) to operation (v) as follows:

(i) Determine a user query phrase based on the user information of the user.

In an aspect of this disclosure, the computer device may extract a user query phrase from the user information of the user. The user query phrase may refer to a search keyword of the user in a browser, such as “comfortable sneakers” or “new mobile phone”.

In a possible implementation, the computer device may acquire a search keyword satisfying a specified requirement from the user information of the user, and determine the search keyword satisfying the specified requirement as the user query phrase. The specified requirement may refer to: a number of times of query is greater than a number of times threshold (for example, a number of times threshold may be set as 10), and a query frequency is greater than a frequency threshold (for example, the query frequency may be set as 0.05).

(ii) Determine a content phrase of each type of candidate recommendation information.

In an aspect of this disclosure, the computer device may extract a corresponding content phrase from each type of candidate recommendation information. The content phrase may refer to a phrase included in the candidate recommendation information, such as a keyword “brand sneakers” or “comfortable and breathable” in an advertisement.

In a possible implementation, the computer device may extract a content phrase in the candidate recommendation information through a natural language processing (NLP) technology.

(iii) Perform phrase prefix matching on the plurality of types of candidate recommendation information according to the user query phrase and the content phrase of each type of candidate recommendation information, and obtain a first reference sorting result of the plurality of types of candidate recommendation information.

In an aspect of this disclosure, the phrase prefix matching is configured for rapidly finding, from the plurality of types of candidate recommendation information, an advertisement related to a user query phrase, so as to find an advertisement highly related to a user interest. Since a phrase rather than a single keyword is first considered during the phrase prefix matching, relevance between advertisement content and user query can be enhanced.

In a possible implementation, an implementation of operation (iii) to perform phrase prefix matching on the plurality of types of candidate recommendation information according to the user query phrase and the content phrase of each type of candidate recommendation information, and obtain a first reference sorting result of the plurality of types of candidate recommendation information may include operation (1) to operation (2) as follows:

(1) Perform character string matching on the user query phrase and the content phrase of each type of candidate recommendation information, and obtain a first matching degree.

In a possible implementation, the computer device may perform character string matching on the user query phrase and the content phrase through a character string matching algorithm. The character string matching algorithm may include any one of the following: a best matching 25 (BM25) algorithm, a brute force (BF) algorithm, a Rabin-Karp (RK) algorithm, and a Knuth-Morris-Pratt (KMP) algorithm.

(2) Determine the first reference sorting result of the plurality of types of candidate recommendation information according to the first matching degree of each type of candidate recommendation information.

In a possible implementation, the computer device may determine a corresponding reference sorting value according to a first matching degree of each type of candidate recommendation information (for example, a reference sorting value of candidate recommendation information having a greatest first matching degree is 1, which represents highest recommendation priority), and then determine the first reference sorting result according to the sorting values of the plurality of types of candidate recommendation information.

(iv) Perform hybrid vector indexing on the plurality of types of candidate recommendation information according to the user query phrase and the content phrase of each type of candidate recommendation information, and obtain a second reference sorting result of the plurality of types of candidate recommendation information.

In an aspect of this disclosure, the hybrid vector indexing combines the sparse vector indexing and the dense vector indexing, such that an obtained sorting result is more comprehensive and accurate.

In a possible implementation, an implementation of operation (iv) to perform hybrid vector indexing on the plurality of types of candidate recommendation information according to the user query phrase and the content phrase of each type of candidate recommendation information, and obtain a second reference sorting result of the plurality of types of candidate recommendation information may include operation (1) to operation (3) as follows:

(1) Perform sparse encoding and dense encoding on the user query phrase, and obtain a first sparse feature vector and a first dense feature vector.

(2) Perform sparse encoding and dense encoding on the content phrase of each type of candidate recommendation information, and obtain a second sparse feature vector and a second dense feature vector that correspond to each type of candidate recommendation information.

In operation (1) to operation (2) mentioned above, the computer device may generate a first sparse feature vector corresponding to the user query phrase and a second sparse feature vector corresponding to the content phrase through sparse encoding. The computer device may generate a first dense feature vector corresponding to the user query phrase and a second dense feature vector that correspond to the content phrase through dense encoding. The above sparse encoding and the above dense encoding provide different feature representation methods. The sparse encoding pays more attention to word frequency information, while the dense encoding pays more attention to semantic information.

In a possible implementation, the computer device may perform encoding on the user query phrase and the content phrase through methods such as a term frequency-inverse document frequency (TF-IDF) method and a bag of words (BoW) model, such that sparse feature vectors are obtained. This is not limited in the aspects of this disclosure.

In a possible implementation, the computer device may perform encoding on the user query phrase and the content phrase through a deep learning model (such as a Word2vec method, a BERT method, or a CNN model), such that dense feature vectors are obtained. This is not limited in the aspects of this disclosure.

(3) Determine the second reference sorting result of the plurality of types of candidate recommendation information according to the first sparse feature vector, the first dense feature vector, and the second sparse feature vector and the second dense feature vector that correspond to each type of candidate recommendation information.

In a possible implementation, an implementation of operation (3) to determine the second reference sorting result of the plurality of types of candidate recommendation information according to the first sparse feature vector, the first dense feature vector, and the second sparse feature vector and the second dense feature vector that correspond to each type of candidate recommendation information may include operation 1) to operation 3) as follows:

1) Perform vector matching on the first sparse feature vector and the second sparse feature vector corresponding to each type of candidate recommendation information, and obtain a second matching degree.

2) Perform vector matching on the first dense feature vector and the second dense feature vector that correspond to the candidate recommendation information, and obtain a third matching degree.

3) Determine the second reference sorting result of the plurality of types of candidate recommendation information according to the second matching degree and the third matching degree of each type of candidate recommendation information.

In an aspect of this disclosure, the computer device may comprehensively consider the second matching degree and the third matching degree, and obtain the second reference sorting result of the plurality of types of candidate recommendation information. For example, the computer device may determine a corresponding first reference sorting value according to the second matching degree corresponding to each type of candidate recommendation information, determine a corresponding second reference sorting value according to the third matching degree corresponding to each type of candidate recommendation information, take an average value of the first reference sorting value and the second reference sorting value that correspond to each type of candidate recommendation information as the fused reference sorting value corresponding to each type of candidate recommendation information, and then determine a second reference sorting result of the plurality of types of candidate recommendation information according to the fused reference sorting value of the plurality of types of candidate recommendation information (for example, candidate recommendation information having a greatest fused reference sorting value ranks first in the second reference sorting result, which represents highest recommendation priority).

For another example, the computer device may take an average value of a second matching degree and a third matching degree that correspond to each type of candidate recommendation information as a fused matching degree corresponding to each type of candidate recommendation information, determine a corresponding third reference sorting value according to the fused matching degree corresponding to each type of candidate recommendation information, and then form the second reference sorting result of the plurality of types of candidate recommendation information according to the third reference sorting value corresponding to each type of candidate recommendation information (for example, candidate recommendation information having a greatest fused matching degree ranks first in the second reference sorting result, which represents highest recommendation priority).

(v) Determine the second sorting result according to the first reference sorting result and the second reference sorting result.

In an aspect of this disclosure, the computer device may comprehensively consider the first reference sorting result and the second reference sorting result, and obtain the second sorting result of the plurality of pieces of candidate recommendation information.

For example, the computer device may convert sorting positions of each type of candidate recommendation information in the first reference sorting result and the second reference sorting result to normalized scores (for example, the higher a sorting position is, the greater a score is; and the lower a sorting position is, the less a score is), obtain the normalized scores of each type of candidate recommendation information, and then determine the second sorting result of the plurality of types of candidate recommendation information according to the normalized scores of each type of candidate recommendation information.

(3) Determine a third sorting result of the plurality of types of candidate recommendation information according to the first sorting result and the second sorting result.

In an aspect of this disclosure, the computer device may comprehensively consider the first sorting result and the second sorting result, and obtain the third sorting result of the plurality of types of candidate recommendation information, that is, a sorting result finally configured for data recommendation. An example implementation of determining the third sorting result of the plurality of types of candidate recommendation information according to the first sorting result and the second sorting result can be obtained with reference to the related descriptions of determining the second sorting result of the plurality of types of candidate recommendation information.

(4) Transmit the recommendation data to the user according to the third sorting result.

In an aspect of this disclosure, the computer device may recommend data to the user according to the third sorting result of the plurality of types of candidate recommendation information. For example, the computer device recommends the corresponding recommendation information to the user according to priority from high to low in the third sorting result.

In consideration of different current service situations, if only one type of recommendation information (such as an advertisement) is required to be recommended to a user in a current service, the computer device can recommend candidate recommendation information that ranks first in the third sorting result to the user. If K types of recommendation information (such as K advertisements K, where K is a positive integer greater than 1) are required to be recommended to the user at a time in a current service, the computer device can recommend top K pieces of candidate recommendation information in the third sorting result to the user together.

In a possible implementation, a case that the candidate recommendation information is transmitted to the user may refer to: The candidate recommendation information (such as an advertisement) is transmitted to a terminal device of the user, and the terminal device displays the candidate recommendation information in a display interface (for example, displays the advertisement at an advertising position).

In a possible implementation, operation (2) to transmit the recommendation data to the user based on the plurality of types of candidate recommendation information may further be implemented in any one of methods as follows:

(1) Transmit the recommendation data to the user based on user preference and the plurality of types of candidate recommendation information.

For example, the computer device may acquire user preference of a user, acquire categories of the plurality of types of candidate recommendation information, and then recommend candidate recommendation information of which a category matches the user preference to the target user. For example, if user preference of a user indicates that the user likes sports, candidate recommendation information belonging to a sport category of the plurality of types of candidate recommendation information can be recommended to the target user.

(2) Transmit the recommendation data to the user based on collaborative filtering and the plurality of types of candidate recommendation information.

For example, the computer device may perform data recommendation by using similarity between users or similarity between recommendation information. For example, if the user and another object have similar interests, and the another object clicks on/taps on a piece of pushed candidate recommendation information (which is marked as candidate recommendation information A), when the plurality of types of candidate recommendation information include the candidate recommendation information A, the candidate recommendation information A may be pushed to the user. For another example, if two types of candidate recommendation information (which are marked as candidate recommendation information A and candidate recommendation information B) have high similarity in content, and the user clicks on/taps on a piece of pushed candidate recommendation information A, when the plurality of pieces of candidate recommendation information include the candidate recommendation information B, the candidate recommendation information B may be pushed to the user.

(3) Transmit the recommendation data to the user based on deep learning and the plurality of types of candidate recommendation information.

For example, the computer device may recommend data to a user by using a deep learning model (such as a collaborative filtering model). For example, candidate recommendation information required to be recommended of a plurality of types of candidate recommendation information is determined according to a deep learning model (for example, the candidate recommendation information required to be recommended may refer to: candidate recommendation information having highest priority outputted by the deep learning model), and is pushed to the user.

(4) Transmit the recommendation data to the user based on context information and the plurality of types of candidate recommendation information.

For example, the computer device may perform data recommendation by using context information (such as a position of a user, a current moment, and a device type) of a user. The context information may help the computer device better understand a current requirement and environment of the user such that more related recommendation information can be recommended. For example, when context information indicates that a position of a user is near a shopping mall, candidate recommendation information related to a store of the plurality of types of candidate recommendation information can be recommended to the target user. For another example, when context information indicates that a current moment belongs to dinner time (such as, 6:30 to 7:00), candidate recommendation information related to a restaurant of the plurality of types of candidate recommendation information can be recommended to the target user.

The above implementation of transmitting the recommendation data to the user based on the plurality of types of candidate recommendation information is merely an example. In addition, the computer device may further implement the recommendation data through various other methods.

In a possible implementation, the predicted triggering rate may be outputted by using a data recommendation model. That is, the computer device may input the first embedding feature vector and the second embedding feature vector to the data recommendation model for processing. The data recommendation model can output a predicted triggering probability of the recommendation information at each of a plurality of recommendation moments. In an aspect of this disclosure, a graph neural network model may be used as the data recommendation model. The graph neural network model may be specifically a graph convolutional network (GPN) model.

Based on this, an implementation of training a data recommendation model may include operation (1) to operation (5) as follows:

(1) Generate a sample interaction graph according to user information of a sample user and a plurality of types of sample recommendation information.

In an aspect of this disclosure, the sample user and the sample recommendation information refer to a user example and a recommendation information example configured for model training. The computer device may acquire user information corresponding to each sample user. The user information of the sample user may include at least one or more types of attribute information of the sample user and interaction information between the sample user and the sample recommendation information. In addition, the computer device may further acquire recommendation information of a plurality of pieces of sample recommendation information. The sample recommendation information may include at least one or more types of content data and metadata.

An example implementation of generating a sample interaction graph can be obtained with reference to the related descriptions of generating the interaction graph in the above aspect.

(2) Perform encoding on the sample interaction graph, and obtain a first embedding feature vector of the sample user and a second embedding feature vector of each type of sample recommendation information.

An example implementation of performing encoding on a sample interaction graph can be obtained with reference to the related descriptions of performing the encoding on the interaction graph in the above aspect.

(3) Input the first embedding feature vector of the sample user and the second embedding feature vector of each type of sample recommendation information to an initial recommendation model for processing, and obtain a predicted triggering probability of each type of sample recommendation information at a target moment.

In an aspect of this disclosure, the initial recommendation model refers to a data recommendation model to be trained. The initial recommendation model is trained such that the data recommendation model can be obtained. Thus, prediction accuracy of the data recommendation model is improved.

In a possible implementation, the initial recommendation model may perform matching on the first embedding feature vector and a second embedding feature vector of each type of sample recommendation information, and obtain a predicted triggering probability of each type of sample recommendation information at a target moment.

(4) Determine target difference data according to the predicted triggering probability and a triggering label of each piece of sample recommendation information at a target moment.

In an aspect of this disclosure, the triggering label, as supervision information of the predicted triggering probability, is configured for representing whether a sample user performs an expected interaction behavior (such as a click-through/tap-through behavior) with sample recommendation information. For example, the predicted triggering probability of the sample recommendation information may refer to a predicted click-through/tap-through probability of a sample advertisement. Then, the triggering label may refer to whether a sample user clicks on/taps on the sample advertisement. Specifically, the triggering label may be a label value of the sample recommendation information. For example, a triggering label of 0 represents that the sample user does not click on/tap on the sample advertisement. A triggering label of 1 represents that the sample user clicks on/taps on the sample advertisement.

In an aspect of this disclosure, the computer device may determine target difference data according to the predicted triggering probability and the triggering label of each type of sample recommendation information at a target moment. The target difference data may be a loss value, and is configured for performing model parameter adjustment on the initial recommendation model. In a possible implementation, the computer device may compute a loss value corresponding to each type of sample recommendation information according to the predicted triggering probability and the triggering label of each type of sample recommendation information at a target moment, then sum loss values corresponding to all types of sample recommendation information, and obtain a total loss value. The total loss value is the target difference data.

(5) Perform model parameter adjustment on the initial recommendation model by using the target difference data, and obtain a data recommendation model.

In an aspect of this disclosure, the computer device performs model parameter adjustment on the initial recommendation model by using the target difference data, and obtains the data recommendation model. Thus, the data recommendation model can more accurately predict the predicted triggering probability of each type of recommendation information. Accuracy of data recommendation is improved. The computer device may further perform a plurality of rounds of iterative training on the initial recommendation model by using a plurality of groups of training samples (each group of training samples include: user information of a sample user and recommendation information of a plurality of types of sample recommendation information). Thus, accuracy of model prediction is further improved.

In a possible implementation, if a user clicks on/taps on recommendation information recommended to the user, the system for recommending data can record a click-through/tap-through behavior on the recommendation information, and add the click-through/tap-through behavior on the recommendation information to subsequent training samples. Thus, prediction accuracy of the data recommendation model can be gradually improved.

The method for recommending data provided in an aspect of this disclosure is described below with examples in combination with an advertisement recommendation scenario. As shown in FIG. 4C, a schematic diagram of a flow for recommending data according to an aspect of this disclosure is shown in FIG. 4C. The flow for recommending data mainly includes operations as follows:

401: Perform data preparation and data preprocessing. The operation mainly includes: collect user information of a user, a plurality of types of recommendation information, and environment information when data recommendation is performed for the user, and perform corresponding preprocessing.

A data preparation stage is described below with an example in which the recommendation information is an advertisement. For example, collected data may include three types as follows:

1. User data, which, for example, may include data as follows:
(1) a user identity (ID), such as: 12345;
(2) user behavior data: a click-through/tap-through record in last 30 days (for example, a user clicks on/taps on sports equipment or an electronic product), a search keyword (for example, a user searches for “comfortable sneakers” or “new mobile phone”), and a browsing history (for example, a user browses a sport website or a science and technology blog);
(3) user features: an age (such as 32 years old), a gender (such as a male), a position (such as Shanghai), and a device type (such as a smartphone); and
(4) user preference, such as: sport type preference (80%), and technology type preference (70%).

2. A plurality of pieces of advertisement data, each of which may include, for example, data as follows:
(1) an advertisement ID, such as: A9876;
(2) advertisement content, such as: a promotion of comfortable sneakers;
(3) advertisement features: a category (such as a sport), a keyword (such as “comfortable” or “wearable”), and an image (such as a product image); and
(4) historical performance: a click-through/tap-through rate (such as 5%), and a conversion rate (such as 2%).

3. Context data (that is, environmental data), which, for example, may include data as follows:
(1) Time: 2024-06-15 10:30:00;
(2) a geographical position: Shanghai; and
(3) a device type: a smartphone.

A data preprocessing stage is described below. In an aspect of this disclosure, different types of data are required to be preprocessed in a targeted manner. Examples are as follows:

(1) Text data: the data may be processed through methods such as TF-IDF and Word2 Vec.

For example, a search keyword “comfortable sneakers” of a user may be converted to an embedding feature vector as follows: [0.12, 0.45, 0.78, 0.36], and a keyword “comfortable” of an advertisement may be converted to an embedding feature vector as follows: [0.22, 0.55, 0.88, 0.46].

(2) Image data: the data may be processed by using a pretrained deep neural network (such as a residual neural network (ResNet)).

(3) Numerical data: the data may be processed through a data standardizatio method.

402: Perform data encoding. For example, the following results may be obtained through data encoding:

User feature vector: an encoded vector corresponding to an age, a gender, a position, and a device type. For example, the user feature vector may be marked as [0.5, 1.0, 0.8, 0.3].

Advertisement feature vector: an encoded vector corresponding to a category, a keyword, and an image. For example, the advertisement feature vector may be marked as [0.7, 0.9, 0.6, 0.4].

Context feature vector: an encoded vector corresponding to time, a geographical position, and a device type. For example, the context feature vector may be marked as [0.1, 0.2, 0.3].

403: Construct an interaction graph and perform encoding on the interaction graph.

The computer device may construct a user node, an advertisement node (such as a recommendation information node), and a context node (such as an environment node) according to the user feature vector, the advertisement feature vector, and the context feature vector respectively. For example, a user node may be marked as a user node 12345. An advertisement node may be marked as an advertisement node A9876. A node connection relationship may exist between nodes. The node connection relationship represents an interaction situation between the nodes. For example, a weight of an edge corresponding to a click-through/tap-through record may be marked as 1.0.

The computer device then learns a node feature of the interaction graph by using the GraphSAGE framework, generates a user embedding feature vector (such as a first embedding feature vector) and an advertisement embedding feature vector (such as a second embedding feature vector) of each advertisement, adjusts a weight by using an attention mechanism, and captures a complex interaction relationship between the user and the advertisement. For example, the user embedding feature vector may be marked as [0.6, 0.7, 0.8, 0.5], and the advertisement embedding feature vector may be marked as [0.7, 0.6, 0.9, 0.4].

404: Perform model training.

The initial recommendation model determines a predicted triggering probability of each advertisement according to the user embedding feature vector and the advertisement embedding feature vector of each advertisement, then computes a total loss value according to the predicted triggering probability and a triggering label (configured for indicating whether a user clicks on/taps on an advertisement) of each advertisement, performs model parameter adjustment on the initial recommendation model according to the total loss value, and obtains the data recommendation model.

405: Perform model prediction.

It is assumed that a user currently browses science and technology news, and a historical record of the user represents a high tendency to click on/tap on an advertisement on a smartphone. Then, the system for recommending data is required to determine which advertisement is displayed to him/her in a current moment (marked as t).

Based on this, the data recommendation model may determine a click-through/tap-through rate (that is, a predicted triggering probability) of each advertisement in a current moment according to the first embedding feature vector of the user and the second embedding feature vector of each advertisement. For example, click-through/tap-through rates of advertisement 1 (an advertisement of a smartphone), advertisement 2 (an advertisement of a smart home), and advertisement 3 (an advertisement of a health product) are 0.10, 0.05, and 0.02 respectively.

Assuming that a click-through/tap-through benefit (that is, resource triggering data) of each advertisement is 1, by multiplying a click-through/tap-through rate of each advertisement by the click-through/tap-through benefit, instant benefits of the three advertisements are obtained as 0.10, 0.05, and 0.02 respectively.

The system for recommending data is required to further compute a future benefit of each advertisement. For example, future benefits of the three advertisements are 0.15, 0.07, and 0.03 respectively, and the conversion parameter A is 0.9. Then, the future benefit of each advertisement is multiplied by the conversion parameter 2, and a product and an instant benefit are summed. Vestigial values VTG of the three advertisements are obtained as 0.235, 0.113, and 0.047 respectively.

The system for recommending data performs advertisement recommendation based on vestigial values VTG of the three advertisements, for example, recommends advertisement 1 having a highest vestigial value VTG to the user.

406: Combine multi-channel cross attention. Multi-channel cross attention is configured for integrating features of a plurality of channels.

In an aspect of this disclosure, a plurality of types of features included in the user, a plurality of types of features included in the advertisement, and a plurality of types of features included in the context are integrated. For example, the features of the user include an age, an interest, and an advertisement click-through/tap-through record. The features of the advertisement include a text, an image, and a keyword. The features of the context include time, a geographic position, and a device type.

Thus, by using a multi-channel cross attention (CCA) mechanism, a global channel dependency can be extracted, a plurality of types of features are comprehensively considered, and an enhanced feature representation is generated. Thus, a feature fusion effect is effectively improved, and accuracy of matching is improved. For example, through the multi-channel cross attention, a plurality of features of the user may be fused into a fused feature [0.6, 0.7, 0.5], a plurality of features of the advertisement may be fused into a fused feature [0.8, 0.6, 0.9], and a plurality of features of the context may be fused into a fused feature [0.4, 0.3, 0.2].

407: Fuse a plurality of types of sorting results, and generate a recommendation list.

The computer device determines a plurality of candidate advertisements and a first sorting result of the plurality of candidate advertisements from an advertisement resource library according to a recommendation value (such as a vestigial value VTG) corresponding to each advertisement, performs phrase prefix matching and hybrid vector indexing on the plurality of candidate advertisements, obtains a reference sorting result of the plurality of candidate advertisements, and generates a third sorting result in combination with a plurality of types of sorting results. A recommendation list may be generated according to the third sorting result. For example, the recommendation list may be [advertisement A9876 (highest degree of correlation), advertisement B4321, and advertisement C5678]. A process for generating the third sorting result can be obtained with reference to the related descriptions of the operation of transmitting the recommendation data to the user according to the recommendation value of each type of recommendation information in the above aspect.

In order to better implement the above method in an aspect of this disclosure, an apparatus in an aspect of this disclosure is provided below.

With reference to FIG. 5, a schematic structural diagram of an apparatus for recommending data according to an aspect of this disclosure is shown in this figure. The apparatus for recommending data may be arranged in a computer device provided in an aspect of this disclosure. The computer device may be the server 102 in the system for recommending data shown in FIG. 1 mentioned above. The apparatus for recommending data shown in FIG. 5 may be a computer program running in a computer device. The apparatus for recommending data may be configured to perform some operations or all operations in the method aspect shown in FIG. 2 or FIG. 3. With reference to FIG. 5, the apparatus for recommending data may include units as follows:
a generating unit 501 configured to generate an interaction graph according to user information of a user and a plurality of types of recommendation information;
a processing unit 502 configured to perform encoding on the interaction graph, and obtain a first embedding feature vector corresponding to the user and a second embedding feature vector corresponding to each type of recommendation information,
the processing unit 502 being further configured to determine a recommendation value of each type of recommendation information according to the first embedding feature vector and the second embedding feature vector corresponding to the recommendation information; and
a recommending unit 503 configured to transmit recommendation data to the user according to the recommendation value of each type of recommendation information.

In a possible implementation, the processing unit 502, when configured to determine a recommendation value of each type of recommendation information according to the first embedding feature vector and the second embedding feature vector corresponding to the recommendation information, is specifically configured to:
determine a predicted triggering probability of the recommendation information at each of a plurality of recommendation moments according to the first embedding feature vector and the second embedding feature vector;
determine resource conversion data according to the predicted triggering probability, resource triggering data, and a conversion parameter; and
determine the recommendation value of the recommendation information according to the resource conversion data and the conversion parameter.

In a possible implementation, the processing unit 502, when configured to determine a predicted triggering probability of the recommendation information at each of a plurality of recommendation moments according to the first embedding feature vector and the second embedding feature vector, is specifically configured to:
perform feature fusion on embedding feature vectors of a plurality of channels included in the first embedding feature vector, and obtain a first fused embedding feature vector;
perform feature fusion on embedding feature vectors of a plurality of channels included in the second embedding feature vector, and obtain a second fused embedding feature vector; and
perform matching on the first fused embedding feature vector and the second fused embedding feature vector, and obtain the predicted triggering probability of the recommendation information at each of the plurality of recommendation moments.

In a possible implementation, the processing unit 502, when configured to perform feature fusion on embedding feature vectors of a plurality of channels included in the first embedding feature vector, and obtain a first fused embedding feature vector, is specifically configured to:
determine a query vector, a key vector, and a value vector that correspond to an embedding feature vector of each channel in the first embedding feature vector;
determine a channel weight of each channel according to the query vector, the key vector, and the value vector that correspond to the embedding feature vector of the channel; and
determine the first fused embedding feature vector according to the embedding feature vector and the channel weight of each channel.

In a possible implementation, the generating unit 501, when configured to generate an interaction graph according to user information of a user and a plurality of types of recommendation information, is specifically configured to:
construct a user node according to the user information of the user, and construct a recommendation information node corresponding to each type of recommendation information according to each type of recommendation information, the user node including attribute information of the user and interaction information between the user and the recommendation information;
acquire environment information when data recommendation is performed for the user, and construct an environment node according to the environment information; and
generate the interaction graph according to the user node, the recommendation information node, the environment node, and node connection relationships.

In a possible implementation, the generating unit 501, when configured to perform encoding on the interaction graph, and obtain a first embedding feature vector corresponding to the user and a second embedding feature vector corresponding to each type of recommendation information, is specifically configured to:
perform information aggregation on a user node and a first association node in the interaction graph, and obtain the first embedding feature vector corresponding to the user, the first association node including a recommendation information node having a connection relationship with the user node; and
perform information aggregation on a recommendation information node corresponding to each type of recommendation information and a second association node in the interaction graph, and obtain the second embedding feature vector corresponding to the recommendation information, the second association node including a recommendation information node having a connection relationship with the recommendation information node and the user node.

In a possible implementation, the recommending unit 503, when configured to transmit recommendation data to the user according to the recommendation value of each type of recommendation information, is specifically configured to:
determine a plurality of types of candidate recommendation information from the plurality of types of recommendation information according to the recommendation value of each type of recommendation information; and
transmit the recommendation data to the user based on the plurality of types of candidate recommendation information.

In a possible implementation, the recommending unit 503, when configured to transmit the recommendation data to the user based on the plurality of types of candidate recommendation information, is specifically configured to:
perform data value sorting on the plurality of types of candidate recommendation information, and obtain a first sorting result;
perform index sorting on the plurality of types of candidate recommendation information, and obtain a second sorting result;
determine a third sorting result of the plurality of types of candidate recommendation information according to the first sorting result and the second sorting result; and
transmit the recommendation data to the user according to the third sorting result.

In a possible implementation, the recommending unit 503, when configured to perform index sorting on the plurality of types of candidate recommendation information, and obtain a second sorting result, is specifically configured to:
determine a user query phrase based on the user information of the user;
determine a content phrase of each type of candidate recommendation information;
perform phrase prefix matching on the plurality of types of candidate recommendation information according to the user query phrase and the content phrase of each type of candidate recommendation information, and obtain a first reference sorting result of the plurality of types of candidate recommendation information;
perform hybrid vector indexing on the plurality of types of candidate recommendation information according to the user query phrase and the content phrase of each type of candidate recommendation information, and obtain a second reference sorting result of the plurality of types of candidate recommendation information; and
determine the second sorting result according to the first reference sorting result and the second reference sorting result.

In a possible implementation, the recommending unit 503, when configured to perform phrase prefix matching on the plurality of types of candidate recommendation information according to the user query phrase and the content phrase of each type of candidate recommendation information, and obtain a first reference sorting result of the plurality of types of candidate recommendation information, is specifically configured to:
perform character string matching on the user query phrase and the content phrase of each type of candidate recommendation information, and obtain a first matching degree; and
determine the first reference sorting result of the plurality of types of candidate recommendation information according to the first matching degree of each type of candidate recommendation information.

In a possible implementation, the recommending unit 503, when configured to perform hybrid vector indexing on the plurality of types of candidate recommendation information according to the user query phrase and the content phrase of each type of candidate recommendation information, and obtain a second reference sorting result of the plurality of types of candidate recommendation information, is specifically configured to:
perform sparse encoding and dense encoding on the user query phrase, and obtain a first sparse feature vector and a first dense feature vector;
perform sparse encoding and dense encoding on the content phrase of each type of candidate recommendation information, and obtain a second sparse feature vector and a second dense feature vector that correspond to each type of candidate recommendation information; and
determine the second reference sorting result of the plurality of types of candidate recommendation information according to the first sparse feature vector, the first dense feature vector, and the second sparse feature vector and the second dense feature vector that correspond to each type of candidate recommendation information.

In a possible implementation, the recommending unit 503, when configured to determine the second reference sorting result of the plurality of types of candidate recommendation information according to the first sparse feature vector, the first dense feature vector, and the second sparse feature vector and the second dense feature vector that correspond to each type of candidate recommendation information, is specifically configured to:
perform vector matching on the first sparse feature vector and the second sparse feature vector corresponding to each type of candidate recommendation information, and obtain a second matching degree;
perform vector matching on the first dense feature vector and the second dense feature vector that correspond to the candidate recommendation information, and obtain a third matching degree; and
determine the second reference sorting result of the plurality of types of candidate recommendation information according to the second matching degree and the third matching degree of each type of candidate recommendation information.

Functions of units of the apparatus for recommending data according to an aspect of this disclosure may be implemented according to the method in the above method aspect. An example implementation process can be obtained with reference to related descriptions in the method aspect of this disclosure.

According to another aspect of this disclosure, units of the apparatus for recommending data shown in FIG. 5 may be separately or wholly combined into one or several other units, or one (or some) of the units may alternatively be divided into a plurality of units having less functions. In this way, the same operations can be implemented without affecting implementation of the technical effects of the aspects of this disclosure. The above units are divided based on logical functions. In actual application, a function of one unit may be implemented by a plurality of units, or functions of a plurality of units are implemented by one unit. In another aspect of this disclosure, the apparatus for recommending data may further include another unit. In actual application, these functions may be cooperatively implemented by another unit, and may be cooperatively implemented by a plurality of units.

According to another aspect of this disclosure, by running a computer program that can perform some operations or all operations involved in the method shown in FIG. 2 or FIG. 3 on a universal computing device, such as a computer, that includes processing elements and storage elements, processing circuitry such as a central processing unit (CPU), a random access memory (RAM), and a read-only memory (ROM), the apparatus for recommending data shown in FIG. 5 can be constructed. Further, the method for recommending data according to an aspect of this disclosure can be implemented. The computer program may be recorded in, for example, a computer-readable storage medium such as a non-transitory computer-readable storage medium, and loaded into the above computing device by using the computer-readable storage medium, and run in the computing device.

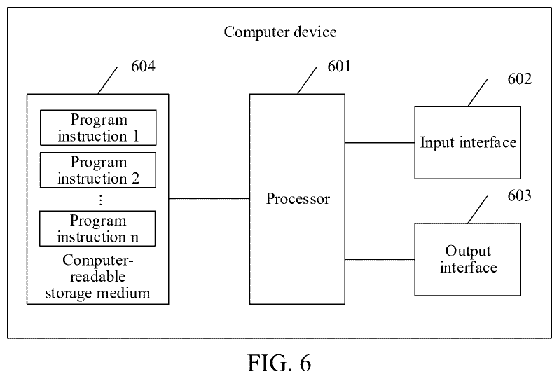

Based on the above method aspect and apparatus aspect, an aspect of this disclosure provides a computer device. With reference to FIG. 6, a schematic structural diagram of a computer device according to an aspect of this disclosure is shown in this figure. The computer device shown in FIG. 6 includes at least a processor 601, an input interface 602, an output interface 603, and a computer-readable storage medium 604. The processor 601, the input interface 602, the output interface 603, and the computer-readable storage medium 604 may be connected by using a bus or through another method.

The computer-readable storage medium 604 may be stored in a memory of the computer device. The computer-readable storage medium 604 is configured to have a computer program stored therein. The computer program includes program instructions. The processor 601 is configured to execute the computer program stored in the computer-readable storage medium 604. The processor 601 (or referred to as a central processing unit (CPU)) is a computing core and a control core of the computer device. The processor is suitable for implementing the computer program, and is specifically suitable for loading and executing the computer program so as to implement a flow of the method shown in FIG. 2 or FIG. 3 mentioned above.

An aspect of this disclosure further provides a computer-readable storage medium (a memory), such as a non-transitory computer-readable storage medium. The computer-readable storage medium is a memory device in a computer device, and is configured to have a program and data stored therein. The computer-readable storage medium herein may include a built-in storage medium in the computer device, and certainly may further include an extended storage medium supported by the computer device. The computer-readable storage medium provides a storage space. The storage space has an operating system of the computer device stored therein. Moreover, the storage space further has a computer program stored therein which is suitable for being loaded and executed by the processor. The computer-readable storage medium herein may be a high-speed RAM memory, or may be a non-volatile memory, for example, at least one magnetic disk memory. In some aspects, the computer-readable storage medium may be at least one computer-readable storage medium located far away from the above processor.

The computer device may be the server 102 in the system for recommending data shown in FIG. 1 mentioned above. In an example implementation, the computer program stored in the computer-readable storage medium 604 may be loaded and executed by the processor 601 so as to implement corresponding operations of the method for recommending data in the method aspect of this disclosure.

In an example implementation, the processor 601, the input interface 602, the output interface 603, and the computer-readable storage medium 604 that are described in an aspect of this disclosure may perform the implementation described in the related aspect of the method provided in FIG. 2 or FIG. 3 in an aspect of this disclosure, or may perform the implementation described in the related aspect of the apparatus provided in FIG. 5 in an aspect of this disclosure.

In the aspects provided by this disclosure, the disclosed method, apparatus, system, and computer device may be implemented through other methods. The aspects described above are merely examples. Division of units is merely a type of division of logic functions. Other division methods may be used in actual implementation. For example, a plurality of units or components may be combined or integrated into another system or some features may be omitted or not performed. In addition, the displayed or discussed mutual couplings, direct couplings, or communication connections may be indirect couplings or communication connections by using some interfaces, apparatuses, or unites, and may be in electrical, mechanical, and other forms.

An aspect of this disclosure further provides a computer program product. The computer program product includes program instructions. The program instructions are stored in a computer-readable storage medium. The processor of the computer device reads the program instructions from the computer-readable storage medium. The processor executes the program instructions to cause the computer device to perform the above method for recommending data.

It is noted that some example units and algorithm steps described in combination with aspects disclosed in this disclosure may be implemented by electronic hardware, or a combination of computer software and electronic hardware. Whether the functions are performed by using hardware or software depends on a specific application and a design constraint condition of the technical solution. A person skilled in the art can implement described functions through different methods for each specific application, and such implementation is not to be considered as falling beyond the scope of this disclosure.

The term “module” or “unit” in the aspects of this disclosure refer to a computer program having a predetermined function or a portion of a computer program, and work together with other related portions to achieve a predetermined objective, and may be all or partially implemented by using software, hardware (such as a processing circuit or a memory), or their combination. Similarly, one processor (or a plurality of processors or memories) may be configured to implement one or more modules or units. In addition, each module or unit may be a portion of an overall module or unit including a function of the module or unit.

Descriptions such as “first” and “second” involved in the aspects of this disclosure are used only for the purpose of description, and are not to be construed as indicating or implying relative importance or implying a number of indicated technical features. Thus, a feature defined by “first” or “second” may explicitly or implicitly include at least one of such features.

Aspects of this disclosure are described above, and the scope of this disclosure is not limited thereto. It is noted that changes or substitutions can be made within the scope disclosed in this disclosure, which all are to fall within the scope of this disclosure. Thus, the scope of this disclosure shall be subject to the scope of the claims.

What is claimed is:

1. A method for recommending data, the method comprising:
generating an interaction graph based on user information of a user and a plurality of types of recommendation information;
obtaining a first embedding feature vector corresponding to the user and a plurality of second embedding feature vectors corresponding to the plurality of types of recommendation information based on the interaction graph;
determining, by processing circuitry, a recommendation value of each type of the plurality of types of recommendation information based on the first embedding feature vector and the second embedding feature vector corresponding to the respective type of recommendation information; and
transmitting recommendation data to the user based on the recommendation value of each type of the plurality of types of recommendation information.

2. The method according to claim 1, wherein
the obtaining the first embedding feature vector includes determining the first embedding feature vector based on a user node and a first association node in the interaction graph; and
the obtaining the second embedding feature vectors includes determining the second embedding feature vector for each of the plurality of types of recommendation information based on a recommendation information node corresponding to the respective type of recommendation information and a second association node in the interaction graph.

3. The method according to claim 1, wherein the determining the recommendation value of each type of the plurality of types of recommendation information comprises:
determining a predicted triggering probability of the respective type of recommendation information at each recommendation time point of a plurality of recommendation time points based on the first embedding feature vector and the second embedding feature vector;
determining resource conversion data based on the predicted triggering probability, resource triggering data, and a conversion parameter; and
determining the recommendation value of the respective type of recommendation information based on the resource conversion data and the conversion parameter.

4. The method according to claim 3, wherein the determining the predicted triggering probability comprises:
combining embedding feature vectors of a plurality of first channels included in the first embedding feature vector to obtain a first fused embedding feature vector;
combining embedding feature vectors of a plurality of second channels included in a second embedding feature vector of the plurality of second embedding feature vectors corresponding to one of the plurality of types of recommendation information to obtain a second fused embedding feature vector; and
matching the first fused embedding feature vector and the second fused embedding feature vector to obtain the predicted triggering probability of the one of the plurality of types of recommendation information at each recommendation time point of the plurality of recommendation time points.

5. The method according to claim 4, wherein the combining the embedding feature vectors of the plurality of first channels included in the first embedding feature vector comprises:
determining a query vector, a key vector, and a value vector corresponding to the embedding feature vector of each first channel of the plurality of first channels in the first embedding feature vector;
determining a channel weight of each first channel of the plurality of first channels based on the query vector, the key vector, and the value vector corresponding to the embedding feature vector of the respective first channel; and
determining the first fused embedding feature vector based on the embedding feature vector and the channel weight of each first channel of the plurality of first channels.

6. The method according to claim 1, wherein the generating the interaction graph comprises:
constructing a user node based on the user information of the user, the user node including attribute information of the user and interaction information between the user and the plurality of types of recommendation information;
constructing a recommendation information node for each type of the plurality of types of recommendation information based on the respective type of recommendation information;
constructing an environment node based on environment information of the user; and
generating the interaction graph based on the user node, the constructed recommendation information nodes corresponding to the plurality of types of recommendation information, the environment node, and node connection relationships.

7. The method according to claim 1, wherein:
the obtaining the first embedding feature vector includes aggregating features from a user node and first association nodes in the interaction graph to obtain the first embedding feature vector corresponding to the user, the first association nodes including recommendation information nodes connected to the user node; and
the obtaining the second embedding feature vectors includes, for each type of the plurality of types of recommendation information, aggregating features from a corresponding recommendation information node and second association nodes in the interaction graph to obtain the second embedding feature vector corresponding to the respective type of recommendation information, the second association nodes including recommendation information nodes connected to the corresponding recommendation information node and the user node.

8. The method according to claim 1, wherein the transmitting the recommendation data to the user comprises:
determining a plurality of types of candidate recommendation information from the plurality of types of recommendation information based on the recommendation value of each type of the plurality of types of recommendation information; and
transmitting the recommendation data to the user based on the plurality of types of candidate recommendation information.

9. The method according to claim 8, wherein the transmitting the recommendation data to the user comprises:
sorting the plurality of types of candidate recommendation information based on recommendation values of the plurality of types of candidate recommendation information to obtain a first sorting result;
sorting the plurality of types of candidate recommendation information based on indices to obtain a second sorting result;
determining a third sorting result of the plurality of types of candidate recommendation information based on the first sorting result and the second sorting result; and
transmitting the recommendation data to the user based on the third sorting result.

10. The method according to claim 9, wherein the sorting the plurality of types of candidate recommendation information based on the indices comprises:
determining a user query phrase based on the user information of the user;
determining a content phrase of each type of the plurality of types of candidate recommendation information;
performing phrase matching between the user query phrase and the content phrase of each type of the plurality of types of candidate recommendation information to obtain matching scores;
sorting the plurality of types of candidate recommendation information based on the matching scores to obtain a first reference sorting result;
performing hybrid vector indexing on the plurality of types of candidate recommendation information based on the user query phrase and the content phrase of each type of the plurality of types of candidate recommendation information;
sorting the plurality of types of candidate recommendation information based on the hybrid vector indexing to obtain a second reference sorting result; and
determining the second sorting result based on the first reference sorting result and the second reference sorting result.

11. The method according to claim 10, wherein the performing the phrase matching comprises:
matching character strings between the user query phrase and the content phrase of each type of the plurality of types of candidate recommendation information to obtain a first matching degree; and
determining the first reference sorting result of the plurality of types of candidate recommendation information based on the first matching degree of each type of the plurality of types of candidate recommendation information.

12. The method according to claim 10, wherein the performing the hybrid vector indexing comprises:
encoding the user query phrase using sparse encoding and dense encoding to obtain a first sparse feature vector and a first dense feature vector;
encoding the content phrase of each type of the plurality of types of candidate recommendation information using sparse encoding and dense encoding to obtain a second sparse feature vector and a second dense feature vector corresponding to each type of the plurality of types of candidate recommendation information; and
determining the second reference sorting result of the plurality of types of candidate recommendation information based on the first sparse feature vector, the first dense feature vector, the second sparse feature vector and the second dense feature vector corresponding to each type of the plurality of types of candidate recommendation information.

13. The method according to claim 12, wherein the determining the second reference sorting result comprises:
matching the first sparse feature vector with the second sparse feature vector corresponding to each type of the plurality of types of candidate recommendation information to obtain a second matching degree;
matching the first dense feature vector with the second dense feature vector corresponding to the each type of the plurality of types of candidate recommendation information to obtain a third matching degree; and
determining the second reference sorting result of the plurality of types of candidate recommendation information based on the second matching degree and the third matching degree of each type of the plurality of types of candidate recommendation information.

14. An apparatus for recommending data, the apparatus comprising:
processing circuitry configured to:
generate an interaction graph based on user information of a user and a plurality of types of recommendation information;
obtain a first embedding feature vector corresponding to the user and a plurality of second embedding feature vectors corresponding to the plurality of types of recommendation information based on the interaction graph;
determine a recommendation value of each type of the plurality of types of recommendation information based on the first embedding feature vector and the second embedding feature vector corresponding to the respective type of recommendation information; and
transmit recommendation data to the user based on the recommendation value of each type of the plurality of types of recommendation information.

15. The apparatus according to claim 14, wherein
the obtain the first embedding feature vector includes determining the first embedding feature vector based on a user node and a first association node in the interaction graph; and
the obtain the second embedding feature vectors includes determining the second embedding feature vector for each of the plurality of types of recommendation information based on a recommendation information node corresponding to the respective type of recommendation information and a second association node in the interaction graph.

16. The apparatus according to claim 14, wherein the processing circuitry is configured to:
determine a predicted triggering probability of the respective type of recommendation information at each recommendation time point of a plurality of recommendation time points based on the first embedding feature vector and the second embedding feature vector;
determine resource conversion data based on the predicted triggering probability, resource triggering data, and a conversion parameter; and
determine the recommendation value of the respective type of recommendation information based on the resource conversion data and the conversion parameter.

17. The apparatus according to claim 16, wherein the processing circuitry is configured to:
combine embedding feature vectors of a plurality of first channels included in the first embedding feature vector to obtain a first fused embedding feature vector;
combine embedding feature vectors of a plurality of second channels included in a second embedding feature vector of the plurality of second embedding feature vectors corresponding to one of the plurality of types of recommendation information to obtain a second fused embedding feature vector; and
match the first fused embedding feature vector and the second fused embedding feature vector to obtain the predicted triggering probability of the one of the plurality of types of recommendation information at each recommendation time point of the plurality of recommendation time points.

18. The apparatus according to claim 17, wherein the processing circuitry is configured to:
determine a query vector, a key vector, and a value vector corresponding to the embedding feature vector of each first channel of the plurality of first channels in the first embedding feature vector;
determine a channel weight of each first channel of the plurality of first channels based on the query vector, the key vector, and the value vector corresponding to the embedding feature vector of the respective first channel; and
determine the first fused embedding feature vector based on the embedding feature vector and the channel weight of each first channel of the plurality of first channels.

19. The apparatus according to claim 14, wherein the processing circuitry is configured to:
construct a user node based on the user information of the user, the user node including attribute information of the user and interaction information between the user and the plurality of types of recommendation information;
construct a recommendation information node for each type of the plurality of types of recommendation information based on the respective type of recommendation information;
construct an environment node based on environment information of the user; and
generate the interaction graph based on the user node, the constructed recommendation information nodes corresponding to the plurality of types of recommendation information, the environment node, and node connection relationships.

20. A non-transitory computer-readable storage medium storing instructions which, when executed by a processor, cause the processor to perform:
generating an interaction graph based on user information of a user and a plurality of types of recommendation information;
obtaining a first embedding feature vector corresponding to the user and a plurality of second embedding feature vectors corresponding to the plurality of types of recommendation information based on the interaction graph;
determining a recommendation value of each type of the plurality of types of recommendation information based on the first embedding feature vector and the second embedding feature vector corresponding to the respective type of recommendation information; and
transmitting recommendation data to the user based on the recommendation value of each type of the plurality of types of recommendation information.
